(19) United States
(12) Patent Application Publication
(10) Pub. No.: US 2017/0092217 A1
(43) Pub. Date: Mar. 30, 2017

(54) VIDEO DISPLAY APPARATUS, INFORMATION PROCESSING METHOD, AND STORAGE MEDIUM

(71) Applicant: CANON KABUSHIKI KAISHA, Tokyo (JP)

(72) Inventor: Ryosuke Mizuno, Tokyo (JP)

(21) Appl. No.: 15/273,393

(22) Filed: Sep. 22, 2016

(30) Foreign Application Priority Data
Sep. 25, 2015 (JP) 2015-188664

(51) Int. Cl. G09G 3/36

(52) U.S. Cl. CPC G09G 3/3685; G09G 2320/066; G09G 2320/0673; G09G 2360/12; G09G 2320/041; G09G 2310/06; G09G 2230/00

(57) ABSTRACT

A video display apparatus includes an input unit, a determination unit, and a change unit. The input unit inputs a current video signal of a current frame and a previous video signal of a previous frame. The determination unit determines whether to perform accelerated drive for correcting the current video signal or perform decelerated drive for correcting the current video signal, based on the current and previous video signals. The change unit changes a correction amount of the current video signal, which is decided based on a relation between the current video signal and the previous video signal, based on a result of the determination by the determination unit.

### BACKGROUND OF THE INVENTION

Field of the Invention

One disclosed aspect of the embodiments relates to a video display apparatus, an information processing method, and a program.

Description of the Related Art

In recent years, various video display apparatuses including a video display device are widely used. Particularly, liquid crystal display apparatuses using a liquid crystal display panel widely spread as display apparatuses for a TV or a PC. In such a liquid crystal display panel, transmittance of light is adjusted by applying a driving voltage in accordance with a video signal level to the liquid crystal display panel, thus making it possible to display a desired video.

Since, in the liquid crystal display panel, a liquid crystal response speed with respect to a change in the driving voltage to be applied is not sufficiently high, there is a problem that an afterimage is generated in a case where a moving image is displayed, for example. Moreover, the liquid crystal response speed has great temperature dependency. Then, as a driving method for improving the liquid crystal response speed, so-called overdrive correction processing has been proposed.

In Japanese Patent Laid-Open No. 2003-207761, disclosed is a technique of performing accelerated drive of liquid crystal display panel by adding an overdrive correction amount, which is obtained by referring to a look-up table from input image data of a current frame and input image data one frame before, to the input image data of the current frame. According to this technique, by increasing or decreasing the overdrive correction amount based on a temperature of a liquid crystal display apparatus, it is possible to suppress a cost increase due to an increase in the look-up table, and control a liquid crystal response speed for each temperature so as to be in a suitable state, and thereby improve image quality of a displayed image.

On the other hand, when a response speed is different between respective colors of RGB, a hue different from an original mixed color is generated, in some cases. In Japanese Patent Laid-Open No. 2003-29713, disclosed is a technique of performing control for each of sub-pixels, which constitute one full pixel, so as to perform accelerated or decelerated drive in each direction which makes effective luminance of each of the sub-pixels even.

In overdrive correction processing including decelerated drive, in the case of increasing or decreasing an overdrive correction amount according to a temperature of a liquid crystal display panel in order to reduce temperature dependency of a liquid crystal response speed, directions for increasing or decreasing are different between accelerated drive and decelerated drive. On the other hand, in the conventional techniques, since a configuration for determining whether to perform the accelerated drive or the decelerated drive is not included, there is a possibility that the overdrive correction amount is increased or decreased in an opposite direction, so that there is a problem that image degradation is caused.

### SUMMARY OF THE INVENTION

A video display apparatus according to one aspect of the embodiments is a video display apparatus, which includes an input unit, a determination unit, and a change unit. The input unit is configured to input a current video signal of a current frame and a previous video signal of a previous frame which is at least one frame before the current frame. The determination unit is configured to determine whether to perform accelerated drive for correcting the current video signal so as to increase a difference of signal levels between the current video signal and the previous video signal, or perform decelerated drive for correcting the current video signal so as to reduce the difference of the signal levels between the current and previous video signals, based on the current and previous video signals. The change unit is configured to change a correction amount of the current video signal, which is decided based on a relation between the current video signal and the previous video signal, based on a result of the determination by the determination unit.

Further features of the disclosure will become apparent from the following description of exemplary embodiments with reference to the attached drawings.

### BRIEF DESCRIPTION OF THE DRAWINGS

FIG. 1 is a view illustrating one example of a hardware configuration of a video display apparatus.

FIG. 2 is a view illustrating one example of a functional configuration and the like of the video display apparatus of an exemplary embodiment 1.

FIGS. 3A to 3C are views illustrating one example of a LUT in a first correction amount calculation portion.

FIG. 4 is a view illustrating one example of a second correction amount calculation portion in the exemplary embodiment 1.

FIGS. 5A to 5H are views schematically illustrating video signal levels and liquid crystal response transitions.

FIG. 6 is a flowchart illustrating a part of information processing in the exemplary embodiment 1.

FIG. 7 is a view illustrating one example of a functional configuration and the like of a video display apparatus of an exemplary embodiment 2.

FIG. 8 is a view illustrating one example of a second correction amount calculation portion in the exemplary embodiment 2.

FIG. 9 is a flowchart illustrating one example of information processing in the exemplary embodiment 2.

FIG. 10 is a view illustrating one example of a second correction amount calculation portion in an exemplary embodiment 3.

FIG. 11 is a flowchart illustrating one example of information processing in the exemplary embodiment 3.

### DESCRIPTION OF THE EMBODIMENTS

### Exemplary Embodiment 1

Hereinafter, an exemplary embodiment 1 will be described based on figures.

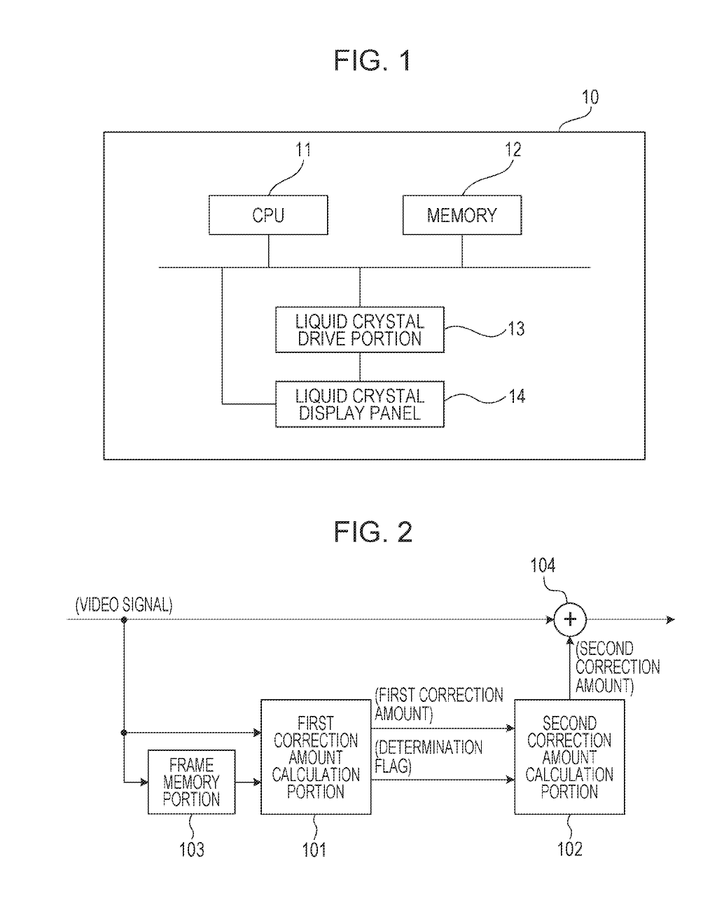

FIG. 1 is a view illustrating one example of a hardware configuration of a video display apparatus 10. As illustrated in FIG. 1, the video display apparatus 10 includes a CPU 11, a memory 12, a liquid crystal drive portion 13, and a liquid crystal display panel 14, as the hardware configuration. The CPU 11 controls an entire of the video display apparatus 10. The memory 12 stores therein a displayed image and a program which are displayed on the video display apparatus 10, and data which is used when the CPU 11 executes processing based on the program (for example, a look-up table (LUT) described below). When the CPU 11 executes processing based on the program stored in the memory 12, for example, a functional configuration of the video display apparatus 10 and processing of a flowchart, both of which will be described below, are realized. The liquid crystal drive portion 13 drives the liquid crystal display panel 14 under control of the CPU 11. The liquid crystal display panel 14 displays the displayed image or the like.

FIG. 2 is a view illustrating one example of the functional configuration and the like of the video display apparatus 10 of the exemplary embodiment 1. As illustrated in FIG. 2, the video display apparatus 10 includes a first correction amount calculation portion 101, a second correction amount calculation portion 102, a frame memory portion 103, and an addition portion 104, as a software configuration.

Via the liquid crystal drive portion 13, an output of the addition portion 104 causes the liquid crystal display panel 14 to display a video thereon. Moreover, in the video display apparatus 10, a video signal which is subjected to, for example, contrast enhancement processing or gamma conversion processing in a video adjustment portion may be input. Note that, it is desired that processing is performed individually for each of sub-pixels constituting one full pixel (for example, RGB). In description below, only one sub-pixel will be described as an example.

The frame memory portion 103 includes a memory controller, stores the video signal to be input, and delays the video signal for at least one frame to output it to the first correction amount calculation portion 101. The one frame has 16.7 msec, for example, in the case of a progressive input of 60 Hz, but not limited thereto, and a video signal of one frame may be displayed by being divided into two or more fields. In the present exemplary embodiment, one frame which is displayed by dividing the one frame is also expressed as one frame. Though it is desired that, as to a video signal to be stored in the frame memory 103, video signal levels for all pixels are stored, compressed signal data whose lower-order bit of the video signal levels is deleted, for example, may be allowed. Note that, in the present exemplary embodiment, the video signal level may be a driving voltage applied to a liquid crystal panel for each of RGB, or may be a gradation value of a video signal before conversion into the driving voltage.

The first correction amount calculation portion 101 decides and outputs a first correction amount and a determination flag for each target pixel according to a video signal level of a current frame, referred to as current video signal level, and a video signal level at least one frame before, referred to as a previous video signal level, which is read out from the frame memory portion 103.

The first correction amount is an overdrive correction amount which is decided in advance under a certain condition. The certain condition is, for example, a temperature condition of the liquid crystal display panel 14. A temperature at a time when the first correction amount is decided is called a reference temperature. In addition, an overdrive correction amount decided with the reference temperature is called a reference overdrive correction amount.

A liquid crystal response speed of the liquid crystal display panel 14 is not sufficiently high with respect to a change in a driving voltage to be applied, and the liquid crystal response speed and a transition waveform have unevenness due to a transition of a video signal level between frames. In addition, since the liquid crystal display panel 14 has an individual difference, the liquid crystal response speed and the transition waveform are different between the respective colors of RGB, in some cases. Further, the liquid crystal response speed has great temperature dependency, and tends to become high as the temperature of the liquid crystal display panel 14 is high, and tends to become low as the temperature of the liquid crystal display panel 14 is low.

Overdrive correction processing indicates processing by which, by performing correction so as to emphasize or suppress a video signal level transition between frames and thereby increasing or decreasing a driving voltage to be applied to the liquid crystal display panel 14, a desired response speed of the liquid crystal display panel 14 is obtained. An amount of the emphasis or an amount of the suppression between frames is the overdrive correction amount. By adding the overdrive correction amount to a video signal level of a current frame, the video display apparatus 10 realizes the overdrive correction processing. The overdrive correction amount is decided in advance based on a combination of a video signal level of a current frame and a video signal level one frame before. Note that, overdrive correction processing by which emphasis is performed so that a response speed becomes high is called accelerated drive. Moreover, overdrive correction processing by which suppression is performed so that the response speed becomes low is called decelerated drive. That is, the accelerated drive is processing of correcting, among a plurality of frames input to the video display apparatus 10, a video signal level of a current frame so that a difference between the video signal level of the current frame and that of a previous frame which is at least one frame before the current frame becomes great. Moreover, the decelerated drive is processing of correcting, among the plurality of frames input to the video display apparatus 10, the video signal level of the current frame so that the difference between the video signal level of the current frame and that of the previous frame which is at least one frame before the current frame becomes small.

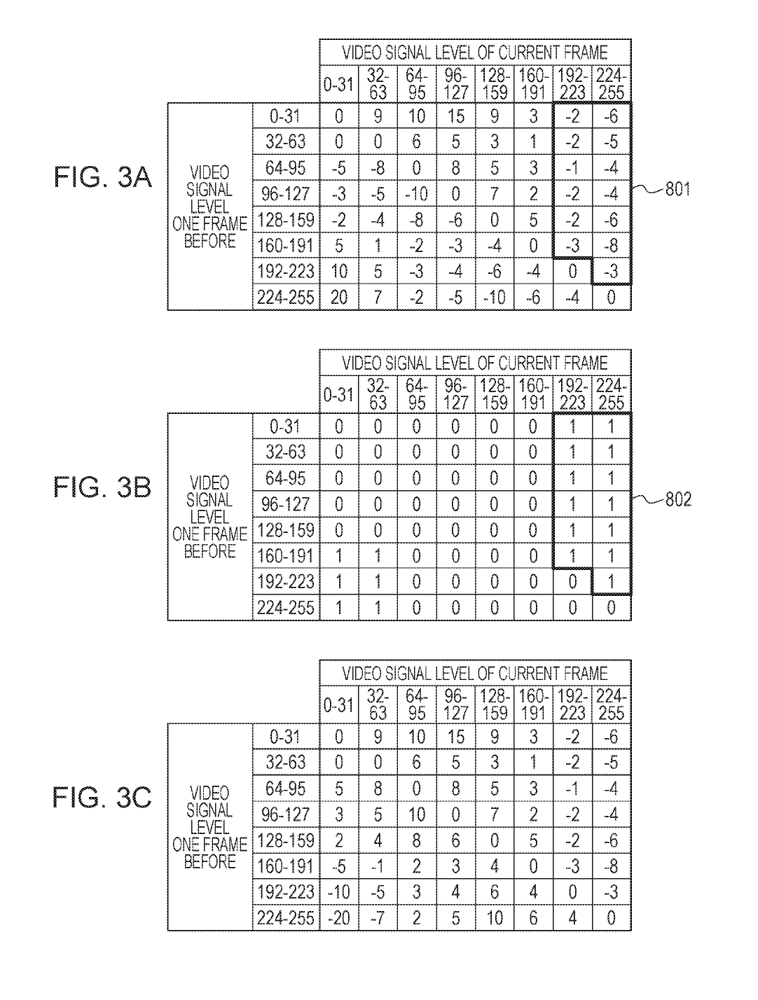

FIGS. 3A to 3C are views illustrating one example of a LUT in the first correction amount calculation portion 101. FIG. 3A indicates first correction amounts in the exemplary embodiment 1, and FIG. 3B indicates determination flags in the exemplary embodiment 1. In both of FIG. 3A and FIG. 3B, each of the video signal level (0 to 255) of the current frame and the video signal level (0 to 255) one frame before is divided into eight sections, and, based on combinations thereof, the first correction amounts and the determination flags are made to correspond to each other. Each of the first correction amounts is the reference overdrive correction amount, and a value (including a sign) to be added to the video signal level of the current frame at the reference temperature. Each of the determination flags is one-bit information, and indicates the accelerated drive in the case of “0” and indicates the decelerated drive in the case of “1”.

For example, each transition inside a thick frame indicated with a reference sign 801 of FIG. 3A is a transition that the video signal level increases between frames, and a liquid crystal response transition is a rising transition. On the other hand, the first correction amount is a minus value, which means that the decelerated drive is being performed. At this time, a determination flag corresponding to the transition indicated with the reference sign 801 is “1” as indicated with a reference sign 802 of FIG. 3B. Generally, as a difference of driving voltages, which are to be applied, between frames is great, a liquid crystal response speed tends to be high. The first correction amounts indicated in FIG. 3A are for an example in which deceleration is performed in a case where a difference of video signal levels between frames is great, and acceleration is performed in a case where the difference of video signal levels between frames is small or a case where a transition is made in intermediate gradation. Thereby, the first correction amount calculation portion 101 makes response speeds of respective transitions substantially uniform, and realizes the overdrive correction processing such that effective luminance is made even for each of the colors of RGB or each of the transitions. Note that, the LUT in FIGS. 3A to 3C is indicated by dividing each of the video signal levels into eight sections, but there is no limitation thereto, though it is desired that the number of divisions with respect to an 8-bit input signal is eight or more. For example, the first correction amount calculation portion 101 may decide the number of divisions so that, between adjacent divided sections, correction unevenness due to a difference of correction amounts is not recognized visually on a displayed image.

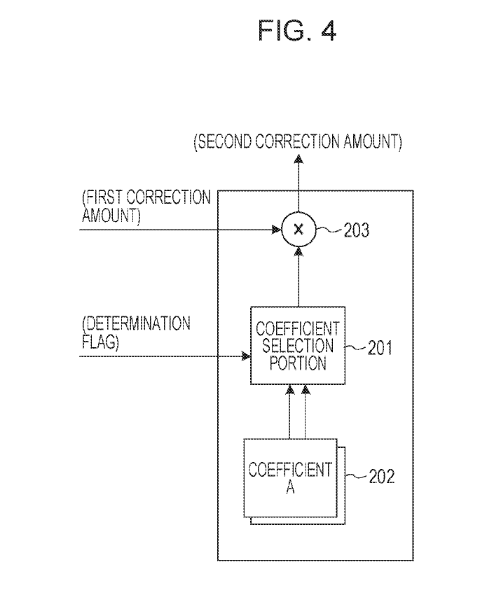

The second correction amount calculation portion 102 calculates a second correction amount according to the first correction amount and the determination flag. FIG. 4 is a view illustrating one example of the second correction amount calculation portion 102 in the exemplary embodiment 1. In the second correction amount calculation portion 102, a coefficient group 202 has at least two coefficients (a coefficient A and a coefficient B). A coefficient selection portion 201 selects the coefficient A in the case of the determination flag=“1” (decelerated drive), and selects the coefficient B in the case of the determination flag=“0” (accelerated drive). In the coefficient group 202, coefficient values for correcting a difference of conditions in a case where a condition at a time of deciding the reference overdrive correction amount and a condition at a time point when the liquid crystal display panel 14 is actually driven are different are stored. For example, for a case where the temperature of the liquid crystal display panel 14 changes from the reference temperature, an increasing/decreasing degree of the overdrive correction amount in accordance with the changed temperature is stored in the coefficient group 202. For example, the second correction amount calculation portion 102 may acquire information from a temperature sensor such as a thermistor with a microcomputer, and may calculate the increasing/decreasing degree from the temperature information and a response characteristic of each liquid crystal display panel 14. In addition, for example, the second correction amount calculation portion 102 may calculate the increasing/decreasing degree by approximating a difference between an optimum amount which is acquired in advance for each temperature and the reference overdrive correction amount, or the like. The temperature sensor may acquire the temperature information of a vicinity of the liquid crystal display panel 14 in the video display apparatus 10. For example, when the temperature becomes low by about 5° C. with respect to the reference temperature, in order to make the liquid crystal response speed high, the second correction amount calculation portion 102 increases the reference overdrive correction amount by 60% in the case of the accelerated drive. Similarly, in order to make the liquid crystal response speed high, the second correction amount calculation portion 102 reduces the reference overdrive correction amount by 60% in the case of the decelerated drive, for example. At this time, the coefficient A=“0.4” and the coefficient B=“1.6” are set. The first correction amount and the coefficient selected in the coefficient selection portion 201 are multiplied in a multiplication portion 203, and the resultant is output from the second correction amount calculation portion 102 as the second correction amount.

The second correction amount is added to the video signal level of the current frame in the addition portion 104. The addition portion 104 has a saturation detection portion, and clip processing is applied in the saturation detection portion so that the video signal level subjected to the addition falls within a dynamic range of an output signal level.

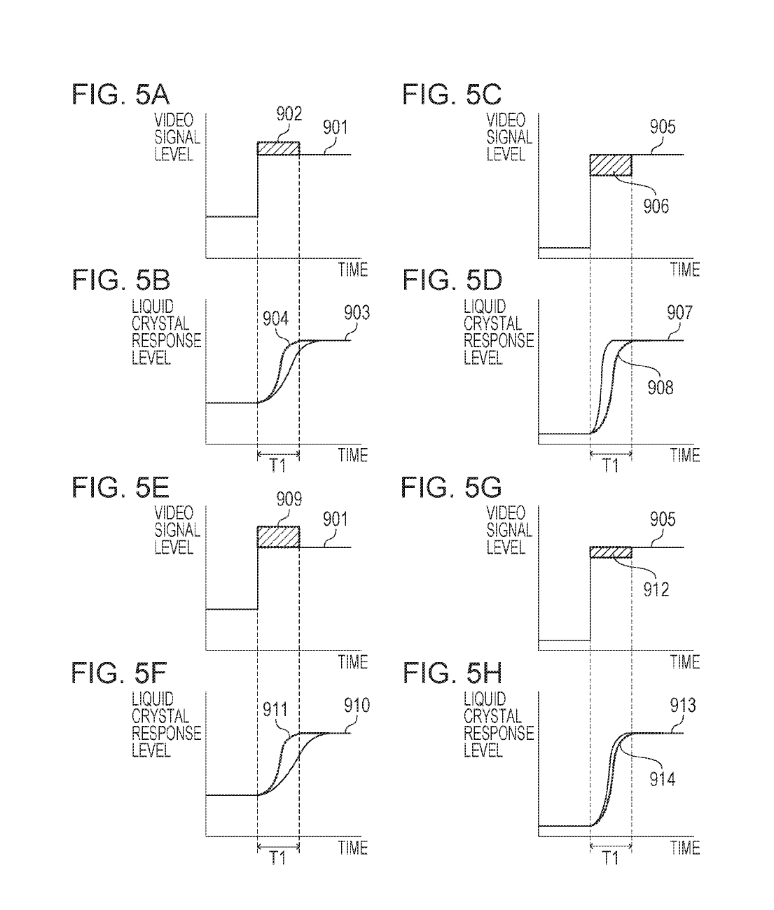

FIGS. 5A to 5H are views schematically illustrating video signal levels and liquid crystal response transitions, and, in FIG. 5A to FIG. 5H, each horizontal axis indicates time and each vertical axis indicates a video signal level or a liquid crystal response level. The liquid crystal response level indicated here indicates a liquid crystal response level which temporally transits according to a video signal level, and may be considered as a luminance value in a displayed image.

FIG. 5A indicates a video signal level at a time of the accelerated drive. A solid line 901 in FIG. 5A indicates a video signal level in a case where the overdrive correction processing is not performed. A solid line 903 in FIG. 5B is a liquid crystal response level corresponding to the solid line 901. Moreover, a hatched part 902 in FIG. 5A indicates the reference overdrive correction amount. A broken line 904 in FIG. 5B is a liquid crystal response level in a case where the reference overdrive correction amount indicated with the hatched part 902 is applied. As indicated with the broken line 904, it is shown that the liquid crystal response speed becomes high by the accelerated drive, and the liquid crystal response level is able to reach approximately a target level at a time when a fixed period (T1) has elapsed.

FIG. 5C indicates a video signal level at a time of the decelerated drive. A solid line 905 in FIG. 5C indicates a video signal level in a case where the overdrive correction processing is not performed. A solid line 907 in FIG. 5D is a liquid crystal response level corresponding to the solid line 905. Moreover, a hatched part 906 in FIG. 5C indicates the reference overdrive correction amount (minus value). A broken line 908 in FIG. 5D is a liquid crystal response level in a case where the reference overdrive correction amount indicated with the hatched part 906 is applied. It is shown that the solid line 907 reaches the target level earlier than the fixed period (T1) of the liquid crystal response level, but, as indicated with the broken line 908, the liquid crystal response level is able to reach approximately the target level at the time when the fixed period (T1) has elapsed, by the accelerated drive.

On the other hand, FIG. 5E and FIG. 5F correspond to a case where the temperature of the liquid crystal display panel 14 becomes lower than the case of FIG. 5A and FIG. 5B, respectively. As indicated with a solid line 910 of FIG. 5F, the liquid crystal response speed becomes low due to lowering of the temperature compared with the solid line 903. At this time, since the accelerated drive is performed, the coefficient B=“1.6” is selected, for example, and a second correction amount (hatched part 909) which is increased compared with the hatched part 902 is added to the video signal level. As a result thereof, as indicated with a broken line 911, it is shown that the liquid crystal response speed becomes high, and the liquid crystal response level is able to reach approximately the target level at the time when the fixed period (T1) has elapsed.

On the other hand, FIG. 5G and FIG. 5H correspond to a case where the temperature of the liquid crystal display panel 14 becomes lower than the case of FIG. 5C and FIG. 5D, respectively.

As indicated with a solid line 913 of FIG. 5H, the liquid crystal response speed becomes low due to lowering of the temperature compared with the solid line 907, and becomes a response speed close to the fixed period (T1) compared with the solid line 907. Here, since the decelerated drive is performed, the coefficient A=“0.4” is selected, for example, and a second correction amount (hatched part 912) which is reduced compared with the hatched part 906 is added to the video signal level. As a result thereof, as indicated with a broken line 914, it is shown that the liquid crystal response speed becomes further low, and the liquid crystal response level is able to reach approximately the target level at the time when the fixed period (T1) has elapsed.

In a case where the reference overdrive correction amount is adjusted in order to absorb the temperature dependency of the liquid crystal response speed, directions for increasing or decreasing vary according to whether to perform the accelerated drive or the decelerated drive. As described above, with a configuration in which an adjustment amount of the reference overdrive correction amount is changed according to a determination result as to whether to perform the accelerated drive or the decelerated drive, it is possible to control the liquid crystal response speed for each temperature of the liquid crystal display panel 14 so as to be in a suitable state, and thereby improve image quality of a displayed image.

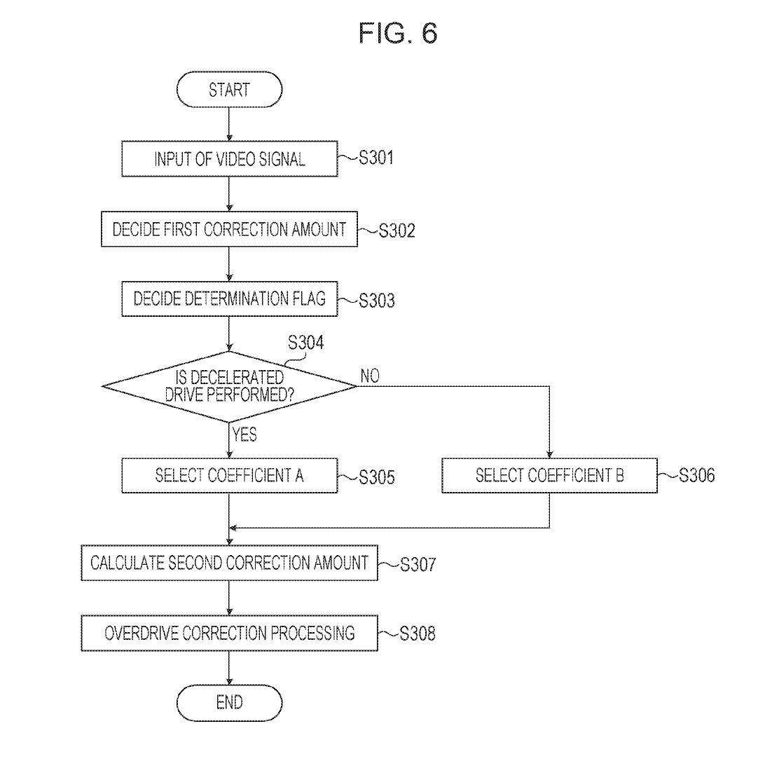

FIG. 6 is a flowchart illustrating a part of information processing in the exemplary embodiment 1.

The CPU 11 receives an input of a video signal for each pixel (step S301). The CPU 11 decides a first correction amount and a determination flag for each target pixel according to a combination of a video signal level of a current frame and that of a frame one frame before (step S302 and step S303). The CPU 11 refers to the determination flag, and determines whether to perform accelerated drive or decelerated drive (step S304). In the case of the decelerated drive (YES at step S304), the CPU 11 selects the coefficient A (step S305). On the other hand, not in the case of the decelerated drive (NO at step S304), the CPU 11 selects the coefficient B (step S306). The CPU 11 calculates a second correction amount obtained by adjusting the first correction amount according to the selected coefficient (step S307). The CPU 11 adjusts the video signal level of the current frame according to the second correction amount (step S308). The CPU 11 repeats the information processing above for each pixel.

As above, according to the present exemplary embodiment, it is possible to change the adjustment amount of the reference overdrive correction amount according to the determination result as to whether to perform the accelerated drive or the decelerated drive. This makes it possible to reduce the temperature dependency of the liquid crystal response speed and control the liquid crystal response speed so as to be in a suitable state by the overdrive correction processing including the decelerated drive, and thereby to improve image quality of a displayed image.

### Exemplary Embodiment 2

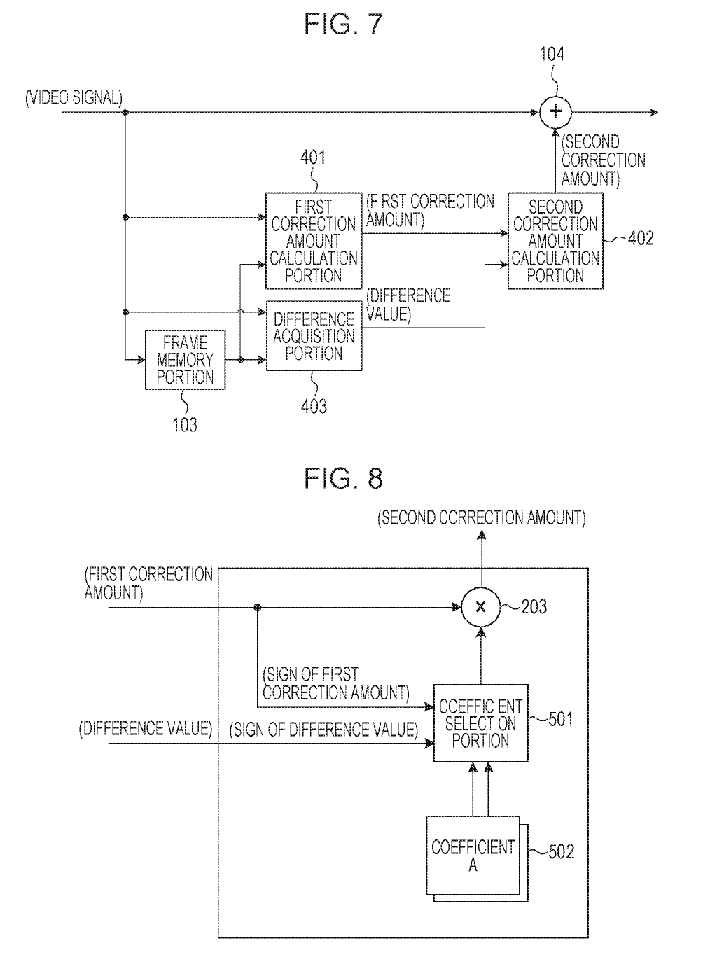

An exemplary embodiment 2 and the exemplary embodiment 1 are different in methods of determining whether to perform the accelerated drive or the decelerated drive. FIG. 7 is a view illustrating one example of a functional configuration and the like of the video display apparatus 10 of the exemplary embodiment 2. The same reference signs are assigned to functions overlapping with those of the exemplary embodiment 1, and description thereof will be omitted.

A first correction amount calculation portion 401 decides and outputs only a first correction amount for each target pixel according to a video signal level of a current frame and a video signal level at least one frame before, which is read out from the frame memory portion 103. Description for the first correction amount is the same as that of the exemplary embodiment 1, for example, as indicated in FIG. 3A, and thus will be omitted. A difference acquisition portion 403 acquires a value obtained by subtracting the video signal level one frame before from the video signal level of the current frame (difference value), and outputs at least only sign information of the difference value (1 bit) to a second correction amount calculation portion 402. The sign information to be output by the difference acquisition portion 403 may indicate “1” in a case where the video signal level of the current frame is smaller than that of the frame one frame before, and indicate “0” in other cases, for example.

FIG. 8 is a view illustrating one example of the second correction amount calculation portion 402 in the exemplary embodiment 2. In FIG. 8, the same reference signs are assigned to functions overlapping with those of the exemplary embodiment 1, and description thereof will be omitted.

A coefficient selection portion 501 determines whether to perform the accelerated drive or the decelerated drive from the sign information of the difference value and sign information of the first correction amount, selects a coefficient from a coefficient group 502 according to a determination result, and outputs the coefficient to the multiplication portion 203. In a case where the sign information of the difference value indicates a plus, the coefficient selection portion 501 is able to judge that the liquid crystal response transition is a rising transition, and is able to judge to perform the accelerated drive in a case where the sign information of the first correction amount indicates a plus, and judge to perform the decelerated drive in a case where the sign information of the first correction amount indicates a minus. On the other hand, in a case where the sign information of the difference value indicates a minus, the coefficient selection portion 501 is able to judge that the liquid crystal response transition is a falling transition, and is able to judge to perform the accelerated drive in the case where the sign information of the first correction amount indicates a minus, and judge to perform the decelerated drive in the case where the sign information of the first correction amount indicates a plus. As above, the coefficient selection portion 501 determines whether to perform the accelerated drive or the decelerated drive from the sign information of the first correction amount and the sign information of the difference value, and selects a coefficient accordingly.

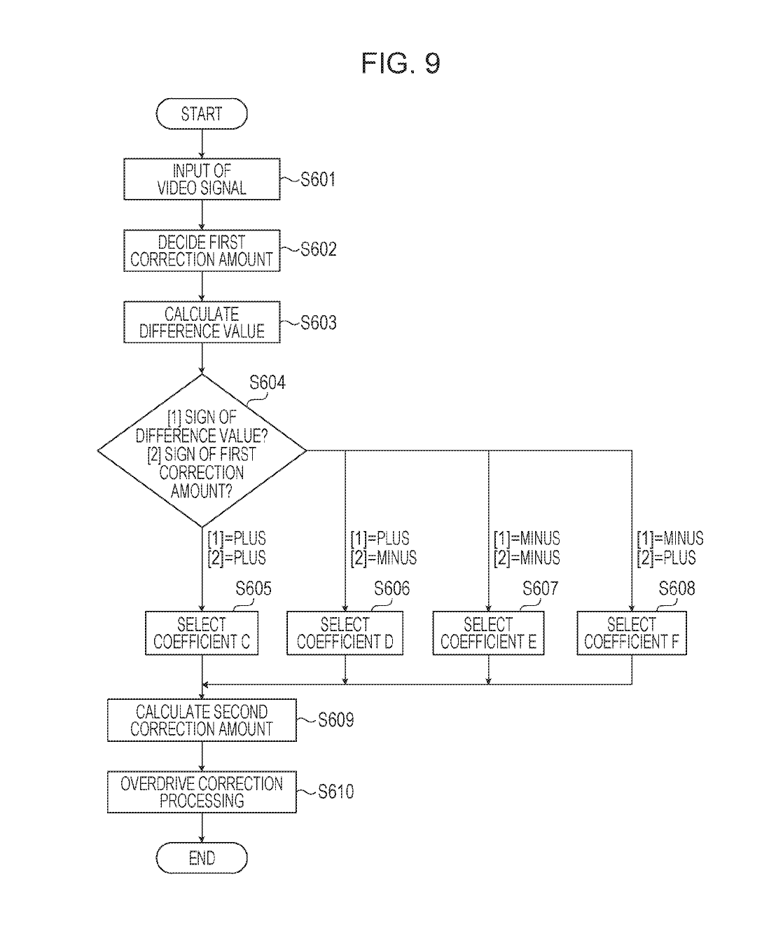

FIG. 9 is a flowchart illustrating one example of information processing in the exemplary embodiment 2. In the exemplary embodiment 2, in addition to determining whether to perform the accelerated drive or the decelerated drive, the CPU 11 determines whether a liquid crystal response transition is a rising transition or a falling transition, and selects a coefficient accordingly. Even when differences of driving voltages to be applied are the same, a liquid crystal response time varies according to whether to increase or reduce the driving voltage in some cases, so that, by determining whether to be the rising transition or the falling transition, it is possible to more accurately calculate the increasing/decreasing degree of the overdrive correction amount in accordance with the temperature.

The CPU 11 receives an input of a video signal for each pixel (step S601). The CPU 11 decides a first correction amount for each target pixel according to a combination of a video signal level of a current frame and that of a frame one frame before (step S602). The CPU 11 acquires a value obtained by subtracting the video signal level one frame before from the video signal level of the current frame (difference value) (step S603). Then, the CPU 11 selects a coefficient from sign information of the difference value and sign information of the first correction amount (step S604).

In a case where the sign information of the difference value indicates a plus and the sign information of the first correction amount indicates a plus, the CPU 11 selects a coefficient C corresponding to the accelerated drive and a rising transition (step S605). In a case where the sign information of the difference value indicates a plus and the sign information of the first correction amount indicates a minus, the CPU 11 selects a coefficient D corresponding to the decelerated drive and the rising transition (step S606). In a case where the sign information of the difference value indicates a minus and the sign information of the first correction amount indicates a minus, the CPU 11 selects a coefficient E corresponding to the accelerated drive and a falling transition (step S607). In a case where the sign information of the difference value indicates a minus and the sign information of the first correction amount indicates a plus, the CPU 11 selects a coefficient F corresponding to the decelerated drive and the falling transition (step S608). The CPU 11 calculates a second correction amount obtained by adjusting the first correction amount according to the selected coefficient (step S609). The CPU 11 adjusts the video signal level of the current frame according to the second correction amount (step S610). The CPU 11 repeats the information processing above for each pixel.

For example, when the temperature becomes low by about 5° C. with respect to the reference temperature, in order to make the liquid crystal response speed high, the reference overdrive correction amount is increased by 60% in the case of the accelerated drive. Similarly, in order to make the liquid crystal response speed high, the reference overdrive correction amount is reduced by 60% in the case of the decelerated drive. At this time, the CPU 11 sets the coefficient C=the coefficient E=“1.6” and the coefficient D=the coefficient F=“0.4”. Note that, the coefficients may be set by considering a difference of response speeds between the rising transition and the falling transition of the liquid crystal response transition. For example, in a case where there is a tendency that the falling transition of the liquid crystal response transition is earlier than the rising transition, the CPU 11 may set the coefficient E=“1.4” and the coefficient F=“0.6” with respect to the coefficient C=“1.6” and the coefficient D=“0.4”, for example.

As above, according to the present exemplary embodiment, it is possible to change an adjustment amount of the reference overdrive correction amount according to a determination result as to whether to perform the accelerated drive or the decelerated drive. This makes it possible to reduce the temperature dependency of the liquid crystal response speed and control the liquid crystal response speed so as to be in a suitable state by the overdrive correction processing including the decelerated drive, and thereby to improve image quality of a displayed image. Moreover, as a method of determining whether to perform the accelerated drive or the decelerated drive, the sign information of the difference value of the video signal level of the current frame and that of the frame one frame before and the sign information of the first correction amount are used. Thereby, compared with the exemplary embodiment 1, the LUT for the time of deciding the determination flag becomes unnecessary, thus making it possible to reduce a scale of the LUT.

Moreover, in addition to determining whether to perform the accelerated drive or the decelerated drive, by further determining whether the liquid crystal response transition is a rising transition or a falling transition, it is possible to change the adjustment amount of the reference overdrive correction amount according to a determination result. Thereby, it becomes possible to perform adjustment better with respect to the liquid crystal response time which varies according to whether the driving voltage to be applied is increased or reduce.

### Exemplary Embodiment 3

Compared with the exemplary embodiments described above, an exemplary embodiment 3 is different in functions of the first correction amount calculation portion 401 and the second correction amount calculation portion 402, but a functional configuration and the like of the video display apparatus 10 in the present exemplary embodiment are the same as those in FIG. 7, which are described in the exemplary embodiment 2, so that description for overlapping functions will be omitted.

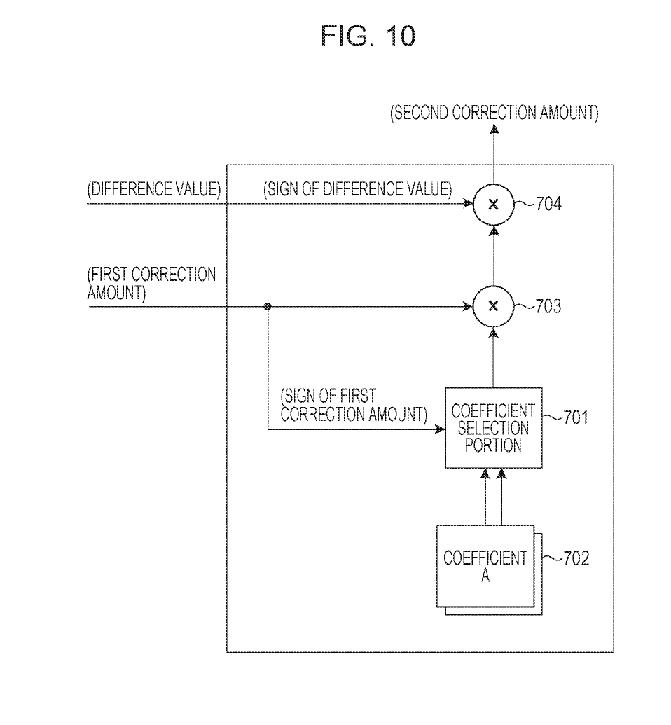

FIG. 10 is a view illustrating one example of the second correction amount calculation portion 402 in the exemplary embodiment 3. In the second correction amount calculation portion 402, sign information of a difference value and sign information of a first correction amount are input. FIG. 3C indicates first correction amounts in the exemplary embodiment 3. Each of the first correction amounts in the exemplary embodiment 3 is set to be a plus value in the case of accelerated drive, and to be a minus value in the case of decelerated drive. A coefficient selection portion 701 determines whether to perform the accelerated drive or the decelerated drive according to the sign information of the first correction amount, selects a coefficient from a coefficient group 702 accordingly, and outputs it to a multiplication portion 703. The multiplication portion 703 multiplies the first correction amount and the coefficient selected in the coefficient selection portion 701. A multiplication result by the multiplication portion 703 has a sign in accordance with whether to perform the accelerated drive or the decelerated drive, but is different from an addition amount to a video signal level of a current frame. Thus, a multiplication portion 704 adds the sign information of the difference value to the multiplication result by the multiplication portion 703. More specifically, in a case where the sign information of the difference value indicates a minus, a liquid crystal response transition is a falling transition, so that the multiplication portion 704 multiplies the multiplication result by the multiplication portion 703 by “−1” (changes a sign of the multiplication result by the multiplication portion 703). Moreover, in a case where the sign information of the difference value indicates a plus, the liquid crystal response transition is a rising transition, so that the multiplication portion 704 multiplies the multiplication result by the multiplication portion 703 by “1” (outputs the multiplication result by the multiplication portion 703 as it is). As illustrated in FIG. 10, by referring to the sign information of the first correction amount, the coefficient selection portion 701 is enabled to determine whether to perform the accelerated drive or the decelerated drive. Further, by referring to the sign information of the difference value, the coefficient selection portion 701 is also enabled to determine whether the liquid crystal response transition is the rising transition or the falling transition.

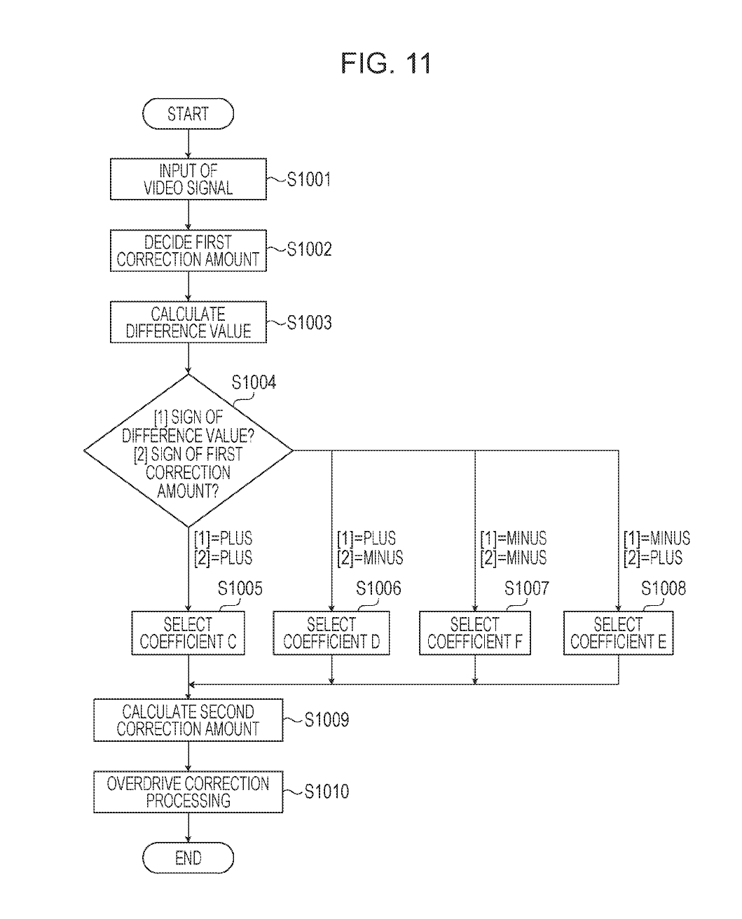

FIG. 11 is a flowchart illustrating one example of information processing in the exemplary embodiment 3.

The CPU 11 receives an input of a video signal for each pixel (step S1001). The CPU 11 decides a first correction amount for each target pixel according to a combination of a video signal level of a current frame and that of a frame one frame before (step S1002). The CPU 11 sets the first correction amount to be a plus value in the case of accelerated drive, and to be a minus value in the case of decelerated drive. The CPU 11 acquires a value obtained by subtracting the video signal level one frame before from the video signal level of the current frame (difference value) (step S1003). Then, the CPU 11 selects a coefficient from sign information of the difference value and sign information of the first correction amount (step S1004). In a case where the sign information of the difference value indicates a plus and the sign information of the first correction amount indicates a plus, the CPU 11 selects a coefficient C corresponding to the accelerated drive and a rising transition (step S1005). In a case where the sign information of the difference value indicates a plus and the sign information of the first correction amount indicates a minus, the CPU 11 selects a coefficient D corresponding to the decelerated drive and the rising transition (step S1006). In a case where the sign information of the difference value indicates a minus and the sign information of the first correction amount indicates a minus, the CPU 11 selects a coefficient F corresponding to the decelerated drive and a falling transition (step S1007). In a case where the sign information of the difference value indicates a minus and the sign information of the first correction amount indicates a plus, the CPU 11 selects a coefficient E corresponding to the accelerated drive and the falling transition (step S1008). The CPU 11 calculates a second correction amount obtained by adjusting the first correction amount according to the selected coefficient and the sign information of the difference value (step S1009). The CPU 11 adjusts the video signal level of the current frame according to the second correction amount (step S1010). The CPU 11 repeats the information processing above for each pixel.

As above, according to the present exemplary embodiment, it is possible to change an adjustment amount of the reference overdrive correction amount according to a determination result as to whether to perform the accelerated drive or the decelerated drive. This makes it possible to reduce the temperature dependency of a liquid crystal response speed and control the liquid crystal response speed so as to be in a suitable state by the overdrive correction processing including the decelerated drive, and thereby to improve image quality of a displayed image. Moreover, as a method of determining whether to perform the accelerated drive or the decelerated drive, the sign information of the difference value of the video signal level of the current frame and that of the frame one frame before and the sign information of the first correction amount are used. Thereby, compared with the exemplary embodiment 1, the LUT for the time of deciding the determination flag becomes unnecessary, thus making it possible to reduce a scale of the LUT.

Further, in addition to determining whether to perform the accelerated drive or the decelerated drive, by further determining whether the liquid crystal response transition is a rising transition or a falling transition, it is possible to change the adjustment amount of the reference overdrive correction amount according to a determination result. Thereby, it becomes possible to perform adjustment better with respect to a liquid crystal response time which varies according to whether the driving voltage to be applied is increased or reduced.

### Exemplary Embodiment 4

Each of the above-described exemplary embodiments has a configuration in which the coefficient is selected according to the determination result as to whether to perform the accelerated drive or the decelerated drive. In an exemplary embodiment 4, description will be given for processing of deciding a coefficient to be applied to the accelerated drive and a coefficient to be applied to the decelerated drive from the same coefficient based on calculation formulas. Note that, only the coefficient selection portion in the above-described exemplary embodiments is substituted with the calculation formulas described below, and any processing of the above-described exemplary embodiments may be applied to the method of determining whether to perform the accelerated drive or the decelerated drive, processing after deciding a coefficient, and the like.

A coefficient which is set in a coefficient group for each temperature of the liquid crystal display panel 14 is set to be COEF. A coefficient applied to the accelerated drive is set to be COEF_A. A coefficient applied to the decelerated drive is set to be COEF_B. Then, COEF_A and COEF_B are respectively decided with the calculation formulas below, for example. Note that, it is set that a range of a value of COEF is −4.0≦COEF≦4.0, and a default value (set value in a case where the temperature of the liquid crystal display panel 14 is the reference temperature) is 1.0.

COEF_A=COEF (formula 1)

COEF_B=2.0−COEF (formula 2)

By using the formula 1 and the formula 2, it becomes possible for the CPU 11 to adjust the reference overdrive correction amount with the same proportion for the accelerated drive and the decelerated drive, and, furthermore, adjust the reference overdrive correction amount without correction in an opposite direction with respect to a temperature influence.

For example, in a case where the temperature of the liquid crystal display panel 14 is the reference temperature, when COEF=1.0 is provided, COEF_A=1.0 and COEF_B=1.0 are obtained, and the reference overdrive correction amount is applied as a second correction amount. In the case of the exemplary embodiment 3, a sign of a first correction amount is added to the second correction amount, which will not be described in the present exemplary embodiment particularly.

Moreover, for example, in a case where the temperature of the liquid crystal display panel 14 is lower than the reference temperature, when COEF=1.6 is provided, COEF_A=1.6 and COEF_B=0.4 are obtained, and, in order to make a liquid crystal response speed high, the liquid crystal response speed is further accelerated in the case of the accelerated drive, and a degree of deceleration is suppressed in the case of the decelerated drive. In addition, for example, in a case where the temperature of the liquid crystal display panel 14 further becomes lower than the reference temperature, when COEF=3.0 is provided, COEF_A=3.0 and COEF_B=−1.0 are obtained, and, in order to make the liquid crystal response speed even higher, the liquid crystal response speed is further accelerated in the case of the accelerated drive. On the other hand, in the case of the decelerated drive, the CPU 11 judges that the liquid crystal response speed becomes lower than a predetermined fixed period (for example, T1 indicated in FIGS. 5A to 5H) due to an influence of the temperature which has become low, sets a minus value for a coefficient value to be applied, and performs the accelerated drive.

As above, according to the present exemplary embodiment, it is possible to change, by using the same coefficient, an adjustment amount of the reference overdrive correction amount according to a determination result as to whether to perform the accelerated drive or the decelerated drive. This makes it possible to reduce the temperature dependency of the liquid crystal response speed and control the liquid crystal response speed so as to be in a suitable state by the overdrive correction processing including the decelerated drive, and thereby to improve image quality of a displayed image.

### Other Exemplary Embodiments

One disclosed aspect of the embodiments supplies a program which realizes one or more functions of the above-described exemplary embodiments to a system or an apparatus via a network or a computer-readable storage medium. The disclosure may be realized by processing that one or more processors in a computer of the system or the apparatus read out and execute the program. Moreover, the disclosure may also be realized by a circuit (for example, an ASIC) which realizes one or more functions.

As above, though description has been given for the suitable exemplary embodiments of the disclosure in detail, the disclosure is not limited to a specific exemplary embodiment relating thereto.

Though description has been given in the above-described exemplary embodiments by taking the liquid crystal display panel 14 as an example of a video display device, any one may be used as long as compensating a response characteristic of the video display device. Moreover, the temperature of the liquid crystal panel is cited as the condition for obtaining the reference overdrive correction amount, but there is no limitation thereto, and driving frequency information of the liquid crystal display panel 14 may be used as well, for example. In this case, the CPU 11 may perform adjustment according to a frame period at a time of driving, and, for example, in a case where a driving frequency is changed from 120 Hz to 60 Hz, a degree of acceleration may be suppressed in the accelerated drive, and a degree of deceleration may be suppressed in the decelerated drive.

Further, a configuration in which the first correction amount is multiplied by a coefficient is provided in any of the exemplary embodiments, but a configuration in which addition and/or subtraction of a coefficient is performed may be adopted.

Moreover, though description has been given by setting the reference overdrive correction amount is single, the video display apparatus 10 may have a plurality of reference overdrive correction amounts and the CPU 11 may select and apply any one of them. For example, the video display apparatus 10 has a reference overdrive correction amount for each of three representative temperature states (a high temperature, a middle temperature, and a low temperature) as to the temperature of the liquid crystal display panel 14, and the CPU 11 applies the reference overdrive correction amount by performing switching according to a change in the temperature. For a small change in the temperature with respect to the three temperature states, the CPU 11 performs adjustment by applying the configuration described in the aforementioned exemplary embodiments.

Further, though the same coefficient group is applied to all pixels in the above-described exemplary embodiments, the CPU 11 may apply different coefficient groups according to, for example, regions in a screen by considering a difference in temperatures between respective positions on the liquid crystal panel. In this case, the CPU 11 may select coefficients of neighboring regions according to whether to perform the accelerated drive or the decelerated drive and/or whether a liquid crystal response transition is a rising transition or a falling transition, and may apply a value obtained by weighted averaging the coefficients according to a position of a target pixel on the screen.

According to each of the above-described exemplary embodiments, by overdrive correction processing including decelerated drive, it is possible to control a liquid crystal response speed to be in a suitable state in accordance with a temperature of a liquid crystal display panel, and improve image quality of a displayed image.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2015-188664, filed on Sep. 25, 2015, which is hereby incorporated by reference herein in its entirety.

What is claimed is:

1. A video display apparatus, comprising:
an input unit configured to input a current video signal of a current frame and a previous video signal of a previous frame which is at least one frame before the current frame;
a determination unit configured to determine whether to perform accelerated drive for correcting the current video signal so as to increase a difference of signal levels between the current video signal and the previous video signal, or perform decelerated drive for correcting the current video signal so as to reduce the difference of the signal levels between the current and previous video signals, based on the current and previous video signals; and
a change unit configured to change a correction amount of the current video signal, which is decided based on a relation between the current video signal and the previous video signal, based on a result of the determination by the determination unit.

2. The video display apparatus according to claim 1, wherein the change unit increases the correction amount in a case where the determination unit determines to perform the accelerated drive, and reduces the correction amount in a case where the determination unit determines to perform the decelerated drive.

3. The video display apparatus according to claim 1, further comprising
a correction amount decision unit configured to decide a correction amount for the current video signal based on the current and previous video signals, wherein
the determination unit determines whether to perform the accelerated drive or the decelerated drive, based on the correction amount decided by the correction amount decision unit.

4. The video display apparatus according to claim 3, further comprising
an acquisition unit configured to acquire a difference value between the current and previous video signals, wherein
the determination unit determines whether to perform the accelerated drive or the decelerated drive, based on a sign of the correction amount which is decided by the correction amount decision unit and a sign of the difference value which is acquired by the acquisition unit.

5. The video display apparatus according to claim 4, wherein
the determination unit further determines whether a response transition of a video display device is a rising transition or a falling transition based on the sign of the correction amount which is decided by the correction amount decision unit and the sign of the difference value which is acquired by the acquisition unit, and
the change unit decides a change amount of the correction amount based on determination results of the determination as to whether to perform the accelerated drive or the decelerated drive and the determination as to whether the response transition of the video display device is the rising transition or the falling transition, both of which are made by the determination unit.

6. The video display apparatus according to claim 1, further comprising
an acquisition unit configured to acquire temperature information in a vicinity of a video display device which displays a video based on the video signal input by the input unit, wherein
the change unit decides a change amount of the correction amount based on the temperature information which is acquired by the acquisition unit.

7. The video display apparatus according to claim 1, wherein the correction amount is a correction amount corresponding to a reference temperature which is defined in advance.

8. A video processing method which is executed by a video display apparatus having an input unit configured to input a video signal, comprising:
determining whether to perform accelerated drive for correcting a current video signal of a current frame, which is input by the input unit, so as to increase a difference of signal levels between the current video signal and a previous video signal of a previous frame which is at least one frame before the current frame, or perform decelerated drive for correcting the current video signal so as to reduce the difference of the signal levels between the current and previous video signals, based on the current and previous video signals; and
changing a correction amount of the current video signal, which is decided based on a relation between the current video signal and the previous video signal based on a result of the determination at the determination step.

9. The video display method according to claim 8, wherein the correction amount is increased in a case where determination to perform the accelerated drive is made at the determining, and the correction amount is reduced in a case where determination to perform the decelerated drive is made at the determining.

10. The video display method according to claim 8, further comprising
deciding a correction amount for the video signal of the current frame based on the video signal of the current frame and the video signal of the previous frame, wherein
determining comprises determining whether to perform the accelerated drive or the decelerated drive based on the correction amount decided at the deciding.

11. A computer-readable storage medium storing a program for causing a computer to execute a method comprising:
determining whether to perform accelerated drive for correcting a current video signal of a current frame, which is input by the input unit, so as to increase a difference of signal levels between the current video signal and a previous video signal of a previous frame which is at least one frame before the current frame, or perform decelerated drive for correcting the current video signal so as to reduce the difference of the signal levels between the current and previous video signals, based on the current and previous video signals; and
changing a correction amount of the current video signal, which is decided based on a relation between the current video signal and the previous video signal based on a result at the determining.

12. The computer-readable storage medium according to claim 11, wherein the correction amount is increased in a case where determination to perform the accelerated drive is made at the determining, and the correction amount is reduced in a case where determination to perform the decelerated drive is made at the determining.

13. The computer-readable storage medium according to claim 11, wherein the method further comprises:
deciding a correction amount for the current video signal based on the current and previous video signals, wherein
determining comprises determining whether to perform the accelerated drive or the decelerated drive based on the correction amount decided at the deciding.
